(19) United States
(12) Patent Application Publication
(10) Pub. No.: US 2008/0211997 A1
(43) Pub. Date: Sep. 4, 2008

(54) POLARIZING PLATES AND LIQUID CRYSTAL DISPLAYS COMPRISING THE SAME

(75) Inventors: Shih-Ming Chen, Hsinchu City (TW); Chyi-Ming Leu, Taichung County (TW); Tzong-Ming Lee, Hsinchu City (TW); Young-Jen Lee, Changhua County (TW); Chia-Chi Huang, Hsinchu County (TW); Chi-Fu Tseng, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/028,029

(22) Filed: Feb. 8, 2008

(30) Foreign Application Priority Data
Nov. 27, 2004 (TW) 96144953

(51) Int. Cl. G02F 1/1335; B32B 27/28; B32B 5/16; C09K 19/02

(52) U.S. Cl. 349/96; 428/473.5; 428/331; 428/330; 428/328; 428/337; 428/1.31

(57) ABSTRACT

A polarizing plate is provided. The polarizing plate includes a polarizing film, a first protective film and a second protective film respectively disposed on both sides of the polarizing film, and a polyimide optical compensation film having thickness direction retardation (Rth) or both, in-plane retardation (R0) and thickness direction retardation (Rth) disposed on the first protective film. The invention also provides a liquid crystal display including the polarizing plate.

### BACKGROUND OF THE INVENTION

1. Field of the Invention

The invention relates to a polarizing plate, and in particular to a polarizing plate comprising transparent protective film and optical compensation film having in-plane retardation (R0) and thickness direction retardation (Rth).

2. Description of the Related Art

Liquid crystal displays with light weight, thin profiles, low power consumption and high resolution are widely used in commercial electronic products, such as, digital watches, calculators, cell phones, notebooks, desktop computers and large-scale LCD TVs. One of the main components thereof is the polarizing plate, which permits specific-directional light to pass through it and is composed of a polarizing film and two protective films. The polarizing film is polarized by directional iodide ions in polyvinyl alcohol polymer. The polyvinyl alcohol film, however, is easily damaged under high temperature and high humidity. Thus, two protective films serving as support and protection to ensure mechanical strength and prolonged lifespan are required by the polyvinyl alcohol film. Currently, the triacetyl cellulose (TAC) protective film is popular used.

High transparency, non-birefringence, tolerance to temperature alteration, light, and humidity and optical uniformity are essential to protective films. Conventional TAC protective films possess high transparency, thin profile and strong adhesion with polarizing film and can be coated on a substrate by the solvent method. However, with the increase in use of LCDs, tolerance within various environments of polarizing products have becomes more severe, limiting TAC film application. For example, the humidity permeate rate of the TAC protective film is about 300 g/m²/day, which is inadequate to protect the polarizing film under high temperature and high humidity, for example, of 60° C.×RH90%×500 hr.

Additionally, the shading effect of LCDs is depended on birefringence and rotatability of liquid crystal molecules. With increasing sizes and use of LCDs, viewability from various angles is an important property such that it is essential to achieve wide-viewing-angle performance. Currently, the simple way to increase viewing angle is to directly add an optical compensation film without fabrication alteration. However, proper thickness, birefringence and high transparency thereof are required.

With various optical properties, the compensation film can be divided into uniaxial film comprising A-plate and C-plate and biaxial film. The refractive index of the A-plate film is ny=nz≠nx, wherein x axis is parallel to the film. The refractive index of the C-plate film is ny=nx=≠nz, wherein z axis is perpendicular to the film. The refractive indexes along x, y and z axes of the biaxial film are different. According to optical symmetrical relationship among liquid crystal molecules in a liquid crystal cell, it is required that a combination of the A-plate film and a negative C-plate film (ny=nx>nz) or the biaxial film is used to increase viewing angle. The A-plate film can be prepared by single-axis extension of PC, PES, PET, PVA or MCOC. The negative C-plate and biaxial films can be prepared by two single-axis extension along various directions, respectively. However, it is difficult to control such fabrication.

### BRIEF SUMMARY OF THE INVENTION

One embodiment of the invention provides a polarizing plate comprising a polarizing film, a first protective film and a second protective film respectively disposed on both sides of the polarizing film, and a polyimide optical compensation film having thickness direction retardation (Rth) or both, in-plane retardation (R0) and thickness direction retardation (Rth) disposed on the first protective film.

One embodiment of the invention provides a polarizing plate comprising a polarizing film, a protective film disposed on one side of the polarizing film, and a polyimide optical compensation film having thickness direction retardation (Rth) or both, in-plane retardation (R0) and thickness direction retardation (Rth) disposed on another side of the polarizing film.

One embodiment of the invention provides a liquid crystal display comprising a liquid crystal cell and two polarizing plates respectively disposed on both sides of the liquid crystal cell. The polarizing plate comprises a polarizing film, a first protective film and a second protective film respectively disposed on both sides of the polarizing film, and a polyimide optical compensation film having thickness direction retardation (Rth) or both, in-plane retardation (R0) and thickness direction retardation (Rth) disposed on the first protective film. The polyimide optical compensation films contact with the liquid crystal cell.

One embodiment of the invention provides a liquid crystal display comprising a liquid crystal cell, a polarizing plate disposed on one side of the liquid crystal cell, and another polarizing plate disposed on another side of the liquid crystal cell. The polarizing plate comprises a polarizing film, a first protective film and a second protective film respectively disposed on both sides of the polarizing film, and a polyimide optical compensation film having thickness direction retardation (Rth) or both, in-plane retardation (R0) and thickness direction retardation (Rth) disposed on the first protective film. The another polarizing plate comprises a polarizing film, a protective film disposed on one side of the polarizing film, and a polyimide optical compensation film having thickness direction retardation (Rth) or both, in-plane retardation (R0) and thickness direction retardation (Rth) disposed on another side of the polarizing film. The polyimide optical compensation films contact with the liquid crystal cell.

One embodiment of the invention provides a liquid crystal display comprising a liquid crystal cell, a polarizing plate disposed on one side of the liquid crystal cell, a third protective film disposed on another side of the liquid crystal cell, another polarizing film disposed on the third protective film, and a fourth protective film disposed on the another polarizing film. The polarizing plate comprises a polarizing film, a first protective film and a second protective film respectively disposed on both sides of the polarizing film, and a polyimide optical compensation film having thickness direction retardation (Rth) or both, in-plane retardation (R0) and thickness direction retardation (Rth) disposed on the first protective film. The polyimide optical compensation film contacts with the liquid crystal cell.

One embodiment of the invention provides a liquid crystal display comprising a liquid crystal cell and two polarizing plates respectively disposed on both sides of the liquid crystal cell. The polarizing plate comprises a polarizing film, a protective film disposed on one side of the polarizing film, and a polyimide optical compensation film having thickness direction retardation (Rth) or both, in-plane retardation (R0) and thickness direction retardation (Rth) disposed on another side of the polarizing film. The polyimide optical compensation films contact with the liquid crystal cell.

One embodiment of the invention provides a liquid crystal display comprising a liquid crystal cell, a polarizing plate disposed on one side of the liquid crystal cell, a second protective film disposed on another side of the liquid crystal cell, another polarizing film disposed on the second protective film, and a third protective film disposed on the another polarizing film. The polarizing plate comprises a polarizing film, a protective film disposed on one side of the polarizing film, and a polyimide optical compensation film having thickness direction retardation (Rth) or both, in-plane retardation (R0) and thickness direction retardation (Rth) disposed on another side of the polarizing film. The polyimide optical compensation film contacts with the liquid crystal cell.

The polarizing plate is a novel optical composition film comprising a polyvinyl alcohol protective film having about zero retardation and composed of transparent resin and nano particles dispersed therein and a self-standing polyimide optical compensation film composed of a negative C-plate or a positive A-plate and a negative C-plate after single-axis extension.

The optical compensation film having thickness direction retardation (Rth) or both, in-plane retardation (R0) and thickness direction retardation (Rth) is disposed on the protective film having about zero retardation. The hardness of the polyimide optical compensation film is increased by merged cycloaliphatic structures. Thus, a solid optical compensation film with negative birefringence and negative C-plate retardation is obtained. Also, the cycloaliphatic-containing polyimide possesses high transparency within 400-700 nm and high solubility. After single-axis extension, an optical compensation film with both, in-plane retardation (R0) and thickness direction retardation (Rth) is thus formed.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIGS. 1-2 show various polarizing plates of the invention.

FIGS. 3-7 show various liquid crystal displays of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

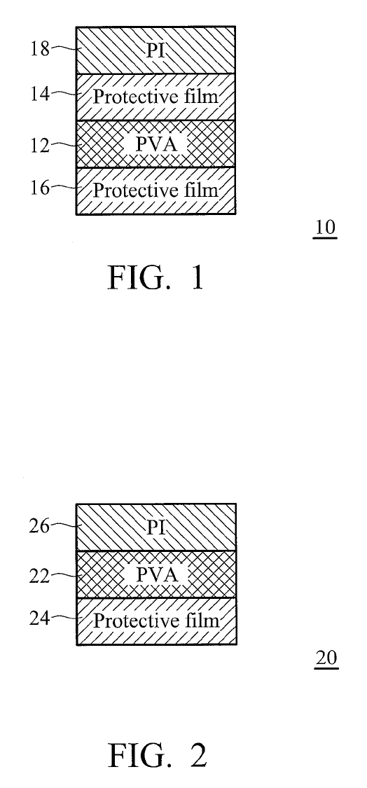

Referring to FIG. 1, one embodiment of the invention provides a polarizing plate. The polarizing plate 10 comprises a polarizing film 12, a first protective film 14, a second protective film 16 and a polyimide optical compensation film 18.

The first protective film 14 and the second protective film 16 are respectively disposed on both sides of the polarizing film 12. The polyimide optical compensation film 18 is disposed on the first protective film 14. Specifically, the polyimide optical compensation film 18 has thickness direction retardation (Rth) or both, in-plane retardation (R0) and thickness direction retardation (Rth).

The polarizing film 12 may be a polyvinyl alcohol film. The first protective film 14 and the second protective film 16 may comprise transparent resin and nano metal oxide particles. The transparent resin may comprise epoxy resin, acrylic resin or a mixture thereof. The epoxy resin may comprise bisphenol A epoxy resin, bisphenol F epoxy resin, bisphenol S epoxy resin, phenolic Novolak epoxy resin, methyl phenol Novolak epoxy resin, cycloaliphatic epoxy resin, naphthalene nitride epoxy resin, hydro-naphthalene epoxy resin or biphenyl epoxy resin. The acrylic resin may comprise epoxy acrylate, polyurethane acrylate, polyester acrylate, 1,6-hexanediol diacrylate (HDDA) or 2-hydroxyethyl methacrylate (HEMA). The nano metal oxide particles may comprise silicon dioxide (SiO₂), titanium dioxide (TiO₂), zirconium dioxide (ZrO₂), aluminum oxide (Al₂O₃), zinc oxide (ZnO), magnesium oxide (MgO) or a mixture thereof, with a diameter of about 1-50 nm.

The first protective film 14 and the second protective film 16 have in-plane retardation (R0) and thickness direction retardation (Rth) of about zero, with transparency exceeding 90%.

The polyimide optical compensation film 18 has the formula:

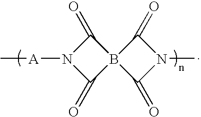

In the formula, when A is cycloaliphatic, B may be aromatic or cycloaliphatic. When A is aromatic, B may be cycloaliphatic. For example, when A comprises

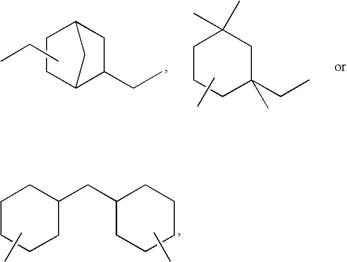

B may comprise

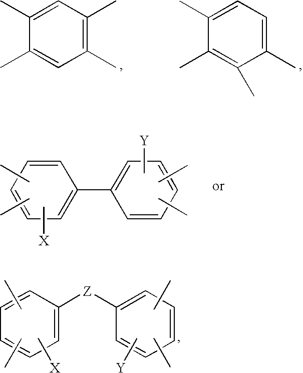

wherein X and Y may comprise —H, —CH₃, —CF₃, —OH, —OR, —Br, —Cl or —I, and Z may comprise —O—, —CH₂—, —C(CH₃)₂—, —Ar—O—Ar—, —Ar—CH₂—Ar—, —O—Ar—C(CH₃)₂—Ar—O—, —O—Ar—Ar—O—, —O—Ar—C(CF₃)₂—Ar—O— or —Ar—C(CH₃)₂—Ar—. B may also comprise

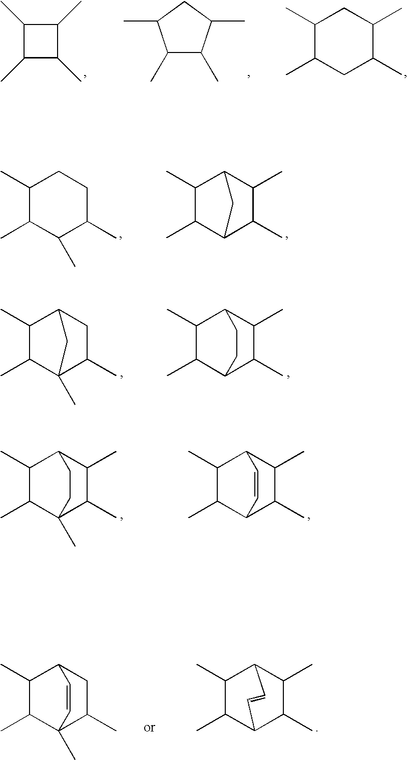

When A comprises

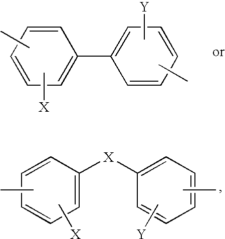

wherein X and Y may comprise —H, —CH₃, —CF₃, —OH, —OR, —Br, —Cl or —I, and Z may comprise —O—, —CH₂—, —C(CH₃)₂—, —Ar—O—Ar—, —Ar—CH₂—Ar—, —O—Ar—C(CH₃)₂—Ar—O—, —Ar—O—Ar—C(CH₃)₂—Ar—O—Ar—, —O—Ar—Ar—O—, —O—Ar—C(CF₃)₂—Ar—O— or —Ar—C(CH₃)₂—Ar—, B may comprise

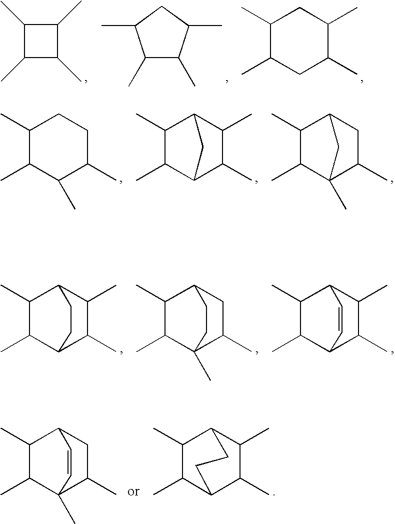

The n value is an integer greater than 1.

The polyimide optical compensation film 18 has in-plane retardation (R0) of about 0-450 nm and thickness direction retardation (Rth) of about 40-900 nm. The polyimide optical compensation film 18 has thickness of about 5-30 μm.

Referring to FIG. 2, one embodiment of the invention provides a polarizing plate. The polarizing plate 20 comprises a polarizing film 22, a protective film 24 and a polyimide optical compensation film 26.

The protective film 24 is disposed on one side of the polarizing film 22. The polyimide optical compensation film 26 is disposed on another side of the polarizing film 22. Specifically, the polyimide optical compensation film 26 has thickness direction retardation (Rth) or both, in-plane retardation (R0) and thickness direction retardation (Rth).

The polarizing film 22 may be a polyvinyl alcohol film. The protective film 24 may comprise transparent resin and nano metal oxide particles. The transparent resin may comprise epoxy resin, acrylic resin or a mixture thereof. The epoxy resin may comprise bisphenol A epoxy resin, bisphenol F epoxy resin, bisphenol S epoxy resin, phenolic Novolak epoxy resin, methyl phenol Novolak epoxy resin, cycloaliphatic epoxy resin, naphthalene nitride epoxy resin, hydro-naphthalene epoxy resin or biphenyl epoxy resin. The acrylic resin may comprise epoxy acrylate, polyurethane acrylate, polyester acrylate, 1,6-hexanediol diacrylate (HDDA) or 2-hydroxyethyl methacrylate (HEMA). The nano metal oxide particles may comprise silicon dioxide (SiO₂), titanium dioxide (TiO₂), zirconium dioxide (ZrO₂), aluminum oxide (Al₂O₃), zinc oxide (ZnO), magnesium oxide (MgO) or a mixture thereof, with a diameter of about 1-50 nm.

The protective film 24 has in-plane retardation (R0) and thickness direction retardation (Rth) of about zero, with transparency exceeding 90%.

The polyimide optical compensation film 26 has the formula:

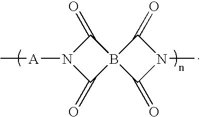

In the formula, when A is cycloaliphatic, B may be aromatic or cycloaliphatic. When A is aromatic, B may be cycloaliphatic. For example, when A comprises

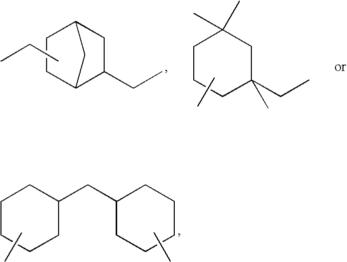

B may comprise

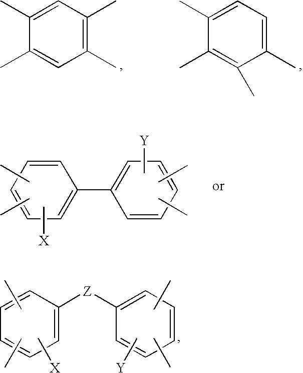

wherein X and Y may comprise —H, —CH₃, —CF₃, —OH, —OR, —Br, —Cl or —I, and Z may comprise —O—, —CH₂—, —C(CH₃)₂—, —Ar—O—Ar—, —Ar—CH₂—Ar—, —O—Ar—C(CH₃)₂—Ar—O—, —O—Ar—Ar—O—, —O—Ar—C(CF₃)₂—Ar—O— or —Ar—C(CH₃)₂—Ar—. B may also comprise

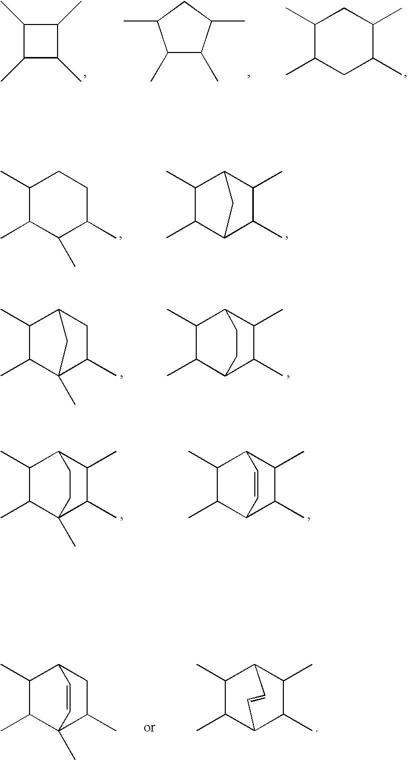

When A comprises

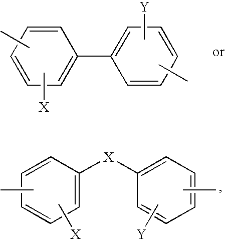

wherein X and Y may comprise —H, —CH₃, —CF₃, —OH, —OR, —Br, —Cl or —I, and Z may comprise —O—, —CH₂—, —C(CH₃)₂—, —Ar—O—Ar—, —Ar—CH₂—Ar—, —O—Ar—C(CH₃)₂—Ar—O—, —Ar—O—Ar—C(CH₃)₂—Ar—O—Ar—, —O—Ar—Ar—O—, —O—Ar—C(CF₃)₂—Ar—O— or —Ar—C(CH₃)₂—Ar—, B may comprise

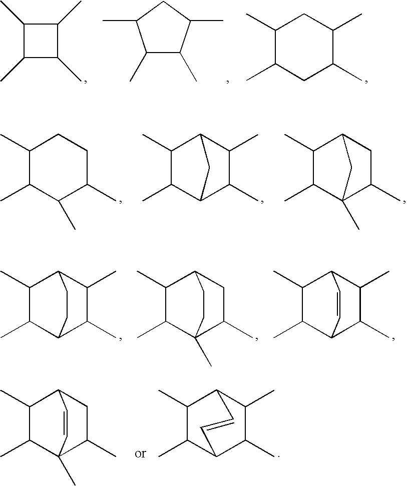

The n value is an integer greater than 1.

The polyimide optical compensation film 26 has in-plane retardation (R0) of about 0-450 nm and thickness direction retardation (Rth) of about 40-900 nm. The polyimide optical compensation film 18 has thickness of about 5-30 μm.

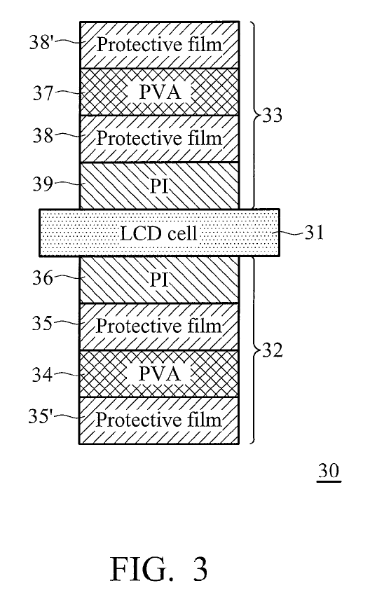

Referring to FIG. 3, one embodiment of the invention provides a liquid crystal display. The liquid crystal display 30 comprises a liquid crystal cell 31 and two polarizing plates 32 and 33 respectively disposed on both sides of the liquid crystal cell 31.

The polarizing plate 32 comprises a polarizing film 34, a first protective film 35, a second protective film 35′ and a polyimide optical compensation film 36.

The first protective film 35 and the second protective film 35′ are respectively disposed on both sides of the polarizing film 34. The polyimide optical compensation film 36 is disposed on the first protective film 35. Specifically, the polyimide optical compensation film 36 has thickness direction retardation (Rth) or both, in-plane retardation (R0) and thickness direction retardation (Rth). The polyimide optical compensation film 36 contacts with the liquid crystal cell 31.

The polarizing plate 33 comprises a polarizing film 37, a first protective film 38, a second protective film 38′ and a polyimide optical compensation film 39.

The first protective film 38 and the second protective film 38′ are respectively disposed on both sides of the polarizing film 37. The polyimide optical compensation film 39 is disposed on the first protective film 38. Specifically, the polyimide optical compensation film 39 has thickness direction retardation (Rth) or both, in-plane retardation (R0) and thickness direction retardation (Rth). The polyimide optical compensation film 39 contacts with the liquid crystal cell 31.

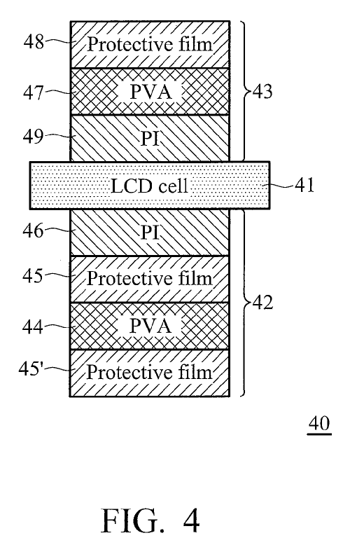

Referring to FIG. 4, one embodiment of the invention provides a liquid crystal display. The liquid crystal display 40 comprises a liquid crystal cell 41, a polarizing plate 42 and another polarizing plate 43. The polarizing plate 42 is disposed on one side of the liquid crystal cell 41. The another polarizing plate 43 is disposed on another side of the liquid crystal cell 41.

The polarizing plate 42 comprises a polarizing film 44, a first protective film 45, a second protective film 45′ and a polyimide optical compensation film 46.

The first protective film 45 and the second protective film 45′ are respectively disposed on both sides of the polarizing film 44. The polyimide optical compensation film 46 is disposed on the first protective film 45. Specifically, the polyimide optical compensation film 46 has thickness direction retardation (Rth) or both, in-plane retardation (R0) and thickness direction retardation (Rth). The polyimide optical compensation film 46 contacts with the liquid crystal cell 41.

The another polarizing plate 43 comprises a polarizing film 47, a protective film 48 and a polyimide optical compensation film 49.

The protective film 48 is disposed on one side of the polarizing film 47. The polyimide optical compensation film 49 is disposed on another side of the polarizing film 47. Specifically, the polyimide optical compensation film 49 has thickness direction retardation (Rth) or both, in-plane retardation (R0) and thickness direction retardation (Rth). The polyimide optical compensation film 49 contacts with the liquid crystal cell 41.

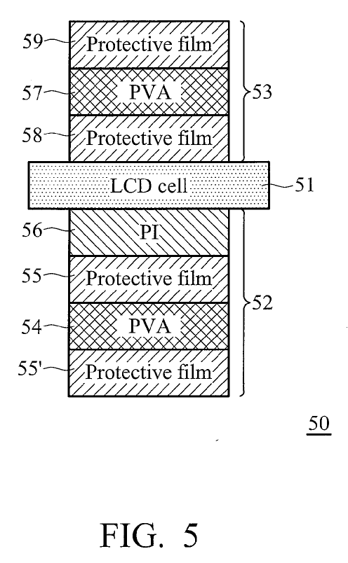

Referring to FIG. 5, one embodiment of the invention provides a liquid crystal display. The liquid crystal display 50 comprises a liquid crystal cell 51, a polarizing plate 52 and another polarizing plate 53. The polarizing plate 52 is disposed on one side of the liquid crystal cell 51. The another polarizing plate 53 is disposed on another side of the liquid crystal cell 51.

The polarizing plate 52 comprises a polarizing film 54, a first protective film 55, a second protective film 55′ and a polyimide optical compensation film 56.

The first protective film 55 and the second protective film 55′ are respectively disposed on both sides of the polarizing film 54. The polyimide optical compensation film 56 is disposed on the first protective film 55. Specifically, the polyimide optical compensation film 56 has thickness direction retardation (Rth) or both, in-plane retardation (R0) and thickness direction retardation (Rth). The polyimide optical compensation film 56 contacts with the liquid crystal cell 51.

The another polarizing plate 53 comprises a polarizing film 57, a third protective film 58 and a fourth protective film 59.

The third protective film 58 and the fourth protective film 59 are respectively disposed on both sides of the polarizing film 57. The third protective film 58 contacts with the liquid crystal cell 51.

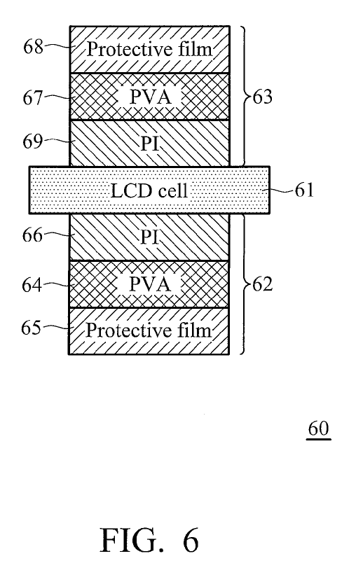

Referring to FIG. 6, one embodiment of the invention provides a liquid crystal display. The liquid crystal display 60 comprises a liquid crystal cell 61 and two polarizing plates 62 and 63 respectively disposed on both sides of the liquid crystal cell 61.

The polarizing plate 62 comprises a polarizing film 64, a protective film 65 and a polyimide optical compensation film 66.

The protective film 65 is disposed on one side of the polarizing film 64. The polyimide optical compensation film 66 is disposed on another side of the polarizing film 64. Specifically, the polyimide optical compensation film 66 has thickness direction retardation (Rth) or both, in-plane retardation (R0) and thickness direction retardation (Rth). The polyimide optical compensation film 66 contacts with the liquid crystal cell 61.

The polarizing plate 63 comprises a polarizing film 67, a protective film 68 and a polyimide optical compensation film 69.

The protective film 68 is disposed on one side of the polarizing film 67. The polyimide optical compensation film 69 is disposed on another side of the polarizing film 67. Specifically, the polyimide optical compensation film 69 has thickness direction retardation (Rth) or both, in-plane retardation (R0) and thickness direction retardation (Rth). The polyimide optical compensation film 69 contacts with the liquid crystal cell 61.

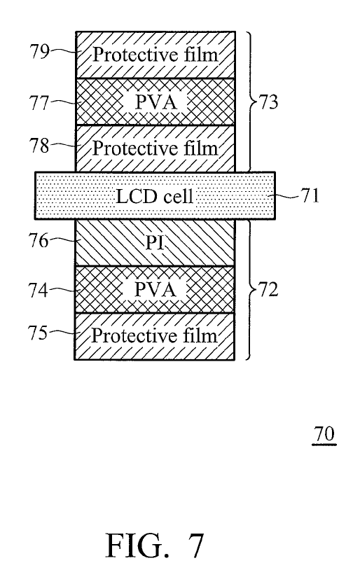

Referring to FIG. 7, one embodiment of the invention provides a liquid crystal display. The liquid crystal display 70 comprises a liquid crystal cell 71, a polarizing plate 72 and another polarizing plate 73. The polarizing plate 72 is disposed on one side of the liquid crystal cell 71. The another polarizing plate 73 is disposed on another side of the liquid crystal cell 71.

The polarizing plate 72 comprises a polarizing film 74, a protective film 75 and a polyimide optical compensation film 76.

The protective film 75 is disposed on one side of the polarizing film 74. The polyimide optical compensation film 76 is disposed on another side of the polarizing film 74. Specifically, the polyimide optical compensation film 76 has thickness direction retardation (Rth) or both, in-plane retardation (R0) and thickness direction retardation (Rth). The polyimide optical compensation film 76 contacts with the liquid crystal cell 71.

The another polarizing plate 73 comprises a polarizing film 77, a second protective film 78 and a third protective film 79.

The second protective film 78 and the third protective film 79 are respectively disposed on both sides of the polarizing film 77. The second protective film 78 contacts with the liquid crystal cell 71.

The polarizing plate is a novel optical composition film comprising a polyvinyl alcohol protective film having about zero retardation and composed of transparent resin and nano particles dispersed therein and a self-standing polyimide optical compensation film composed of a negative C-plate or a positive A-plate and a negative C-plate after single-axis extension.

The optical compensation film having thickness direction retardation (Rth) or both, in-plane retardation (R0) and thickness direction retardation (Rth) is disposed on the protective film having about zero retardation. The hardness of the polyimide optical compensation film is increased by merged cycloaliphatic structures. Thus, a solid optical compensation film with negative birefringence and negative C-plate retardation is obtained. Also, the cycloaliphatic-containing polyimide possesses high transparency within 400-700 nm and high solubility. After single-axis extension, an optical compensation film with both, in-plane retardation (R0) and thickness direction retardation (Rth) is thus formed.

### EXAMPLE 1

### Preparation of B1317-BAPB-co-B1317-BAPPm (PI-BAB)

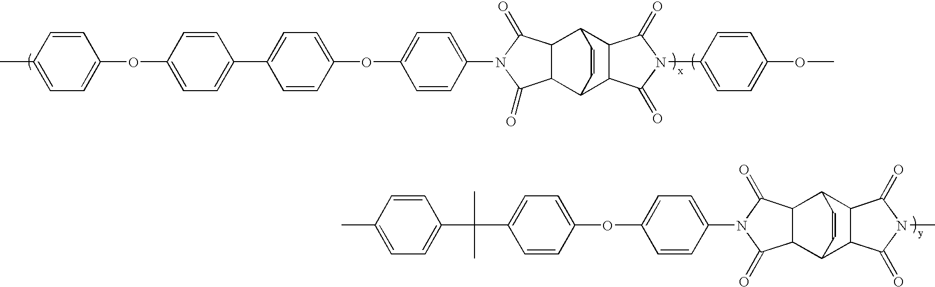

3.05 g BAPB (diamine) and 1.46 g BAPPm (diamine) were completely dissolved in 30 g cresol under nitrogen at room temperature. 3.0 g B1317 (dianhydride) was then added and continuously stirred for 3 hours after B1317 was completely dissolved to form a sticky PAA solution. Next, the PAA solution was thermally imidized (220° C.) for 3 hours to prepare PI-BAB (polyimide). The PI-BAB solution was then coated on a glass. After removal of solvent in an oven, a transparent and colorless polyimide film was prepared. The thickness, in-plane retardation (R0) and thickness direction retardation (Rth) thereof were then measured and recited as in Table 1.

### EXAMPLE 2

### Extension of Polyimide Film (1)

The 30 μm PI-BAB film was extended by a single-axis extension machine. The extension temperature was 210° C. The extension ratio was 1.1 (10%). The thickness, in-plane retardation (R0) and thickness direction retardation (Rth) thereof were then measured and recited as in Table 1.

### EXAMPLE 3

### Extension of Polyimide Film (2)

The 30 μm PI-BAB film was extended by a single-axis extension machine. The extension temperature was 210° C. The extension ratio was 1.2 (20%). The thickness, in-plane retardation (R0) and thickness direction retardation (Rth) thereof were then measured and recited as in Table 1.

TABLE 1

| | Thickness (μm) | R0 (nm) | Rth (nm) |
|---|---|---|---|
| PI-BAB | 34 | 0 | 671 |
| PI-BAB (10%) | 32 | 130 | 652 |
| PI-BAB (20%) | 29 | 448 | 850 |

### EXAMPLE 4

### Reliability Test

First, the colorless polyimide (PI) material (PI-BAB) was dissolved in DMAc or cyclopentanone to form a coating solution. The coating solution was then coated on a HyTAC substrate and baked from 80° C. to 150° C. by a rising-temperature rate of 2° C./min to form a film. After film formation, the adhesion strength between the HyTAC substrate and the PI film was verified to meet 5B by the grid method.

The reliability test was performed as follow. First, the PI coating solution was coated on the HyTAC substrate via 80 μm and 200 μm scrapers to prepare PI test samples with various thicknesses. The baking condition was the same as aforementioned. After film formation, the PI test samples were placed under 80° C. for 500 hours to test the reliability. The test results were recited as in Tables 2 and 3.

TABLE 2
the test results of transparency (TT %) and haze (Hz %)

| | PI | | | | | | |
|---|---|---|---|---|---|---|---|
| | thickness | Hz % | TT % | Hz % | TT % | | |
| Samples | (μm) | Before test | | After test | | ΔHz % | ΔTT % |
| HyTAC + | 7 | 1.64 | 90.65 | 2.73 | 90.98 | 1.09 | 0.33 |
| PI | | | | | | | |
| HyTAC + | 14 | 1.00 | 90.32 | 2.17 | 90.26 | 1.17 | −0.06 |
| PI | | | | | | | |
| HyTAC | 0 | 1.72 | 92.42 | 2.25 | 92.01 | 0.53 | −0.41 |

TABLE 3
the test results of thickness direction retardation (Rth)

| | PI thickness | Rth (nm) | Rth (nm) | ΔRth |
|---|---|---|---|---|
| Samples | (μm) | Before test | After test | (nm) |
| HyTAC + PI | 7 | 165.4 | 171.9 | 6.5 |
| HyTAC + PI | 14 | 368.5 | 376.2 | 7.7 |
| HyTAC | 0 | −2.9 | −5.6 | −2.7 |

Currently, the tolerable range of ΔRth is less than 8. In the invention, after the reliability test, the largest ΔRth was merely 7.7, within the tolerable range.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polarizing plate, comprising:
a polarizing film;
a first protective film and a second protective film respectively disposed on both sides of the polarizing film; and
a polyimide optical compensation film having thickness direction retardation (Rth) or both, in-plane retardation (R0) and thickness direction retardation (Rth) disposed on the first protective film.

2. The polarizing plate as claimed in claim 1, wherein the polarizing film is a polyvinyl alcohol film.

3. The polarizing plate as claimed in claim 1, wherein the first and second protective films comprise transparent resin and nano metal oxide particles with a diameter of about 1-50 nm.

4. The polarizing plate as claimed in claim 3, wherein the transparent resin comprises epoxy resin, acrylic resin or a mixture thereof.

5. The polarizing plate as claimed in claim 3, wherein the nano metal oxide particles comprise silicon dioxide (SiO₂), titanium dioxide (TiO₂), zirconium dioxide (ZrO₂), aluminum oxide (Al₂O₃), zinc oxide (ZnO), magnesium oxide (MgO) or a mixture thereof.

6. The polarizing plate as claimed in claim 1, wherein the polyimide optical compensation film has the formula: 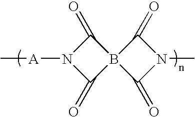
, wherein when A is cycloaliphatic, B is aromatic or cycloaliphatic, when A is aromatic, B is cycloaliphatic, and n is an integer greater than 1.

7. The polarizing plate as claimed in claim 1, wherein the thickness direction retardation (Rth) is about 40-900 nm and the in-plane retardation (R0) is about 0-450 nm.

8. The polarizing plate as claimed in claim 1, wherein the first and second protective films have in-plane retardation (R0) and thickness direction retardation (Rth) of about zero.

9. The polarizing plate as claimed in claim 1, wherein the polyimide optical compensation film has thickness of about 5-30 μm.

10. A polarizing plate, comprising:
a polarizing film;
a protective film disposed on one side of the polarizing film; and
a polyimide optical compensation film having thickness direction retardation (Rth) or both, in-plane retardation (R0) and thickness direction retardation (Rth) disposed on another side of the polarizing film.

11. The polarizing plate as claimed in claim 10, wherein the polarizing film is a polyvinyl alcohol film.

12. The polarizing plate as claimed in claim 10, wherein the first and second protective films comprise transparent resin and nano metal oxide particles with a diameter of about 1-50 nm.

13. The polarizing plate as claimed in claim 12, wherein the transparent resin comprises epoxy resin, acrylic resin or a mixture thereof.

14. The polarizing plate as claimed in claim 12, wherein the nano metal oxide particles comprise silicon dioxide (SiO₂), titanium dioxide (TiO₂), zirconium dioxide (ZrO₂), aluminum oxide (Al₂O₃), zinc oxide (ZnO), magnesium oxide (MgO) or a mixture thereof.

15. The polarizing plate as claimed in claim 10, wherein the polyimide optical compensation film has the formula: 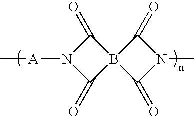
, wherein when A is cycloaliphatic, B is aromatic or cycloaliphatic, when A is aromatic, B is cycloaliphatic, and n is an integer greater than 1.

16. The polarizing plate as claimed in claim 10, wherein the thickness direction retardation (Rth) is about 40-900 nm and the in-plane retardation (R0) is about 0-450 nm.

17. The polarizing plate as claimed in claim 10, wherein the first and second protective films have in-plane retardation (R0) and thickness direction retardation (Rth) of about zero.

18. The polarizing plate as claimed in claim 10, wherein the polyimide optical compensation film has thickness of about 5-30 μm.

19. A liquid crystal display, comprising:
a liquid crystal cell; and
two polarizing plates as claimed in claim 1 respectively disposed on both sides of the liquid crystal cell, wherein the polyimide optical compensation films contact with the liquid crystal cell.

20. A liquid crystal display, comprising:
a liquid crystal cell; and
a polarizing plate as claimed in claim 1 disposed on one side of the liquid crystal cell, wherein the polyimide optical compensation film contacts with the liquid crystal cell; and
another polarizing plate comprising a polyimide optical compensation film having thickness direction retardation (Rth) or both, in-plane retardation (R0) and thickness direction retardation (Rth) disposed on another side of the liquid crystal cell, wherein the polyimide optical compensation film contacts with the liquid crystal cell.

21. The liquid crystal display as claimed in claim 20, wherein the another polarizing plate further comprises a polarizing film and a protective film, wherein the protective film is disposed on one side of the polarizing film and the polyimide optical compensation film is disposed on another side of the polarizing film.

22. A liquid crystal display, comprising:
a liquid crystal cell; and
a polarizing plate as claimed in claim 1 disposed on one side of the liquid crystal cell, wherein the polyimide optical compensation film contacts with the liquid crystal cell;
a third protective film disposed on another side of the liquid crystal cell;
another polarizing film disposed on the third protective film; and
a fourth protective film disposed on the another polarizing film.

23. A liquid crystal display, comprising:
a liquid crystal cell; and
two polarizing plates as claimed in claim 10 respectively disposed on both sides of the liquid crystal cell, wherein the polyimide optical compensation films contact with the liquid crystal cell.

24. A liquid crystal display, comprising:
a liquid crystal cell; and
a polarizing plate as claimed in claim 10 disposed on one side of the liquid crystal cell, wherein the polyimide optical compensation film contacts with the liquid crystal cell;
a second protective film disposed on another side of the liquid crystal cell;
another polarizing film disposed on the second protective film; and
a third protective film disposed on the another polarizing film.
